(19) United States
(12) Patent Application Publication
(10) Pub. No.: US 2020/0102184 A1
(43) Pub. Date: Apr. 2, 2020

(54) MULTI-CAGE LIFT INSTALLATION AND METHOD FOR OPERATING A MULTI-CAGE LIFT INSTALLATION

(71) Applicants: thyssenkrupp Elevator AG, Essen (DE); thyssenkrupp AG, Essen (DE)

(72) Inventors: Richard THUM, Kornwestheim (DE); Marius MATZ, Filderstadt (DE); Eduard STEINHAUER, Nürtingen (DE)

(73) Assignees: thyssenkrupp Elevator AG, Essen (DE); thyssenkrupp AG, Essen (DE)

(21) Appl. No.: 16/497,021

(22) PCT Filed: Mar. 21, 2018
(86) PCT No.: PCT/EP2018/057090

§ 371 Date: Sep. 24, 2019

(30) Foreign Application Priority Data
Mar. 29, 2017 (DE) 10 2017 205 354.2

(51) Int. Cl. B66B 1/34; B66B 5/00; B66B 5/02; B66B 11/04; B66B 1/28

(52) U.S. Cl. CPC B66B 1/3407; B66B 1/3492; B66B 1/3461; B66B 1/3423; B66B 9/003; B66B 5/02; B66B 11/0407; B66B 1/28; B66B 2201/302; B66B 5/0031

(57) ABSTRACT

A method for operating a multi-car elevator system having a shaft system with at least one lift shaft, a plurality of elevator cars that can be moved individually in the shaft system, and a control system. Data about the cars is provided at time intervals. When the provision of data relating to a first car fails, a shaft position of said first car is determined. A quarantine section of the shaft system is determined, in which the first car is located by means of the determined shaft position, and the determined quarantine section is blocked for the other cars of the system. The invention further relates to a multi-car elevator system configured for the implementation of such a method.

The invention relates to a multi-car elevator system as well as a method for operating a multi-car elevator system, wherein the multi-car elevator system contains a shaft system with at least one lift shaft, a plurality of elevator cars that are individually movable in the shaft system and a control system. In particular, in order to be able to control the movement of the elevator cars in a coordinated manner and to reliably prevent collisions of elevator cars, data of the elevator cars are provided at time intervals.

For example, multi-car elevator systems are known to be elevator systems in which two or more elevator cars are moved individually in a single lift shaft, i.e. essentially independently of each other. In such elevator systems, the movement of the elevator car can be carried out in particular by means of rope drives, which are in particular known under the name TWIN®.

In addition, in the state of the art multi-car elevator systems with several lift shafts are known, in which two or more elevator cars in a lift shaft can be moved individually and changing elevator cars between lift shafts is possible. For such a shaft change, these multi-car elevator systems comprise in particular special shaft change units. The movement of the elevator cars can be carried out in such multi-car elevator systems in particular by means of a linear motor drive, a friction wheel drive or a rack-and-pinion drive. Multi-car elevator systems with several lift shafts and elevator cars that can be moved individually in these lift shafts are particularly known as MULTI®.

A problem with such multi-car elevator system arises when one of the elevator cars is affected by a fault, in particular a communication fault. In such a case, for safety reasons a multi-car elevator system cannot continue to operate in its normal operating mode, in particular as there is a risk that an elevator car will collide with the elevator car affected by the fault.

In order to be able to continue to operate a multi-car elevator system even if an elevator car is affected by a communication fault, document EP 2 041 015 B1 proposes a method for controlling elevator cars with which, in the event of a detected communication fault, the elevator car affected by the communication fault is moved to a parking position outside the movement path, so that at least one remaining elevator car can continue to be operated to all floors as far as possible.

This proposed solution presupposes, on the one hand, that the elevator system comprises appropriate parking positions, which increases the space required for the elevator system. On the other hand, the solution presupposes that the elevator car affected by the fault can continue to be moved, which is not always the case, especially not without the risk of collision.

Against this background, it is an object of the present invention to improve a method for operating a multi-car elevator system and a multi-car elevator system, wherein in particular safe operation of the elevator system should continue to be possible in the event of a fault related to an elevator car.

To solve this problem, a method for operating a multi-car elevator system and a multi-car elevator system according to the independent claims are proposed. Further advantageous embodiments of the invention are described in the dependent claims and illustrated in the figures.

The proposed solution provides for a method for operating a multi-car elevator system, which includes a shaft system with at least one lift shaft, a plurality of elevator cars that can be individually moved in the shaft system and a control system. Elevator cars data are provided at time intervals, wherein in the absence of the provision of the data of at least one first elevator car of the multi-car elevator system a shaft position of said elevator car is determined, a quarantine section of the shaft system in which the first elevator car is located by means of the determined shaft position is determined and the specific quarantine section is blocked for the other elevator cars of the multi-car elevator system. Blocking the quarantine section advantageously secures the area around the elevator car, so that there is no risk of collision between the at least one first elevator car of the multi-car elevator system and the other elevator cars of the elevator system. In addition, the fact that the blocking only relates to a section of the shaft system means that the other elevator cars can advantageously continue to move in the shaft system outside the quarantine section. In this way, the conveying capacity of the multi-car elevator system is advantageously increased in the event of a deviation from normal operation.

The following data are provided individually or in combination as data of the elevator cars: status data that signal that the respective elevator car is working correctly; confirmation data, in response to received data; operational data, in particular with regard to current speed, acceleration, deceleration, jolting, loading, direction of travel and/or stopping times; position data; error messages.

In the event that it is provided that a plurality of different data of the elevator cars are provided, the lack of part of the data is a lack of data within the meaning of the invention. For example, if it is provided that confirmation data, operating data and position data of the elevator cars of the multi-car elevator system are always provided at intervals, and only confirmation data and operating data of a first elevator car are provided, but not the position data, this is already a failure to provide the data of the first elevator car.

The provision of the data at time intervals is advantageously carried out at predetermined time intervals. If several different data of the elevator cars are provided, it is provided in particular that the different data are provided at different time intervals. If, for example, status data and position data of the elevator cars are provided, it is provided in particular that the position data are provided at short time intervals, almost continuously, for example every 15 milliseconds, whereas status information is sent in longer time intervals, such as every 500 milliseconds.

The provision of the data can be carried out both by wire and wirelessly, in particular by means of a radio communication.

In particular, it is provided that the elevator cars of the multi-car elevator system are embodied to collect and send the corresponding data. Advantageously, the elevator cars each comprise a corresponding control unit, containing a corresponding sensor and/or an evaluation unit and/or a transmitting unit and/or a receiving unit. The provision of the data of the elevator cars is thus advantageously carried out by the elevator cars or their control unit itself in such an embodiment. In particular in this exemplary embodiment, wireless provision of the data of the elevator cars is advantageously provided, in particular to reduce the wiring cost.

In addition, monitoring of the elevator cars is provided as an embodiment variant, in particular by means of the control system of the multi-car elevator system, wherein the control system provides the data by monitoring the elevator cars. Advantageously, the multi-car elevator system includes, in particular in this case, a shaft information system, which provides the control system in particular with position data and/or operating data of the elevator cars.

According to an advantageous embodiment of the invention, a lack of provision of the data results if the data or at least part of the data specified to be provided are not provided within a given time interval. According to a further advantageous embodiment of the invention, a lack of the provision of the data results if the data or if at least some of the data specified for provision are not provided within several directly consecutive predetermined time intervals, in particular within two directly consecutive time intervals. This makes the multi-car elevator system advantageously more robust against singular communication faults, with which single-occurrence problems occur when providing the data of the elevator car.

A lack of provision of the data of at least one first elevator car may, in particular depending on the data that is not provided, causes the problem that a shaft position of at least one first elevator car cannot be determined precisely. Advantageously, in this case, a probable shaft position of said at least one first elevator car is determined, in particular based on the last available data relating to the shaft position of the at least one first elevator car. Determining the probable shaft position of the at least one first elevator car is an identification of the shaft position in the sense of the present invention. The shaft position can in particular also be a shaft section, especially if the shaft position cannot be precisely determined.

Based on the determined shaft position, a shaft section about said shaft position, namely the quarantine section, is advantageously determined in such a way that the first elevator car is reliably located in this shaft section, i.e. with 100 percent probability. In particular, if the shaft position of the first elevator car can only be vaguely determined, it is provided that the shaft section can extend over multiple lift shafts and/or can include an entire lift shaft.

By blocking the quarantine section, entry into the quarantine section by further elevator cars of the multi-car elevator system is advantageously prevented. If necessary, further elevator cars located in the quarantine section may advantageously be moved out from the quarantine section in such a way as to prevent a collision with the first elevator car. If, for example, a further elevator car followed the first elevator car, safe removal from the quarantine section can be carried out by reversing the direction of the further elevator car. In particular, provision may also be made for all the elevator cars in the quarantine section to be stopped, preferably at a floor stop of the elevator system. This advantageously allows the disembarkation of people in the elevator cars.

According to a further advantageous embodiment of the invention, it is provided that the control system of the multi-car elevator system captures the provided data. Advantageously, the control system further detects the lack of provision of the data of at least one first elevator car. In particular, it is provided that the control system is a decentralized control system with a plurality of control units. The collection of the provided data by the control system or the detection of a lack of provision of the data of one of the elevator cars by the control system may be carried out in particular by one or more of the control units of the decentralized control system.

According to a particularly advantageous embodiment of the invention, position data of the elevator cars with respect to the position of the respective elevator car of the multi-car elevator system in the shaft system are provided as data at time intervals. Said position data can be collected, for example, by means of a shaft information system. Shaft information systems are known in the state of the art. For example, these may comprise measuring strips provided with barcodes that are disposed along the lift shafts, wherein the elevator cars comprise detection devices for detecting the barcode. The barcodes are assigned to clearly defined positions in the shaft system. Alternatively, the elevator cars may have position detection units to record the current shaft position at which the respective elevator car is located. The position data of the elevator cars are advantageously recorded by the control system in order to be able to take into account the respective position of the elevator cars in the shaft system when allocating elevator cars to calls placed by users. Furthermore, the position data are advantageously used by the control system to monitor the observance of distances of the elevator cars between each other, in particular for compliance with safety distances, minimum distances and/or maximum distances between successive elevator cars.

In particular, it is provided that in the absence of the provision of the data of the first elevator car, the first elevator car will be stopped, in particular by triggering a braking device of the first elevator car, preferably by triggering the service brake of the first elevator car or the catching device. This advantageously prevents an elevator car from being moved in the shaft system in an incorrect state as rapidly as possible. In particular, this advantageously prevents an elevator car from being moved out of control, as it were from “flying blind” in the shaft system. According to an advantageous design variant, in the absence of the provision of the data of the first elevator car, a command is issued by the control system to stop the first elevator car at the next floor stop in relation to the first elevator car. Advantageously, a confirmation signal is also requested by the control system. If the confirmation signal is provided, the elevator car is stopped at the next floor stop. If, on the other hand, the confirmation signal is absent, an emergency stop of the first elevator car is advantageously initiated immediately.

According to a further advantageous embodiment of the invention, the control system determines the shaft position of the first elevator car taking into account at least one of the following criteria: last recorded position data of the first elevator car; most recently recorded movement parameters of the first elevator car; last recorded destination floors of the first elevator car; signal transition times for the provision of the data of the elevator cars; recently recorded error messages. In particular, it is provided that taking into account at least one of the aforementioned criteria the position of the first elevator car at which the first elevator car comes to a standstill after triggering an emergency stop is extrapolated as the shaft position. In particular, the stopping position of the first elevator car is determined as the shaft position based on the last recorded position data with respect to the first elevator car and taking into account the last known movement parameters with regard to the first elevator car, such as for example the last known speed and the last known acceleration. Alternatively or additionally, it is advantageously provided that the last recorded destination floors of the first elevator car are used to determine the shaft position. The most recently recorded destination floors include in particular the floor of the last stop of the first elevator car and at least the floor that was to be approached next by the first elevator car. For example, if the control system has the information that the first elevator car has stopped on the fifth floor and should next approach the eighth floor, wherein this stop has not yet been carried out according to the information available to the control system, the region between the fifth floor and the eighth floor is advantageously determined as the shaft position. In addition, the last available movement parameters are advantageously taken into account in the determination of the shaft position, for example, the last known speed can indicate that starting from the fifth floor at least the sixth floor must have been reached, but the eighth floor cannot have been reached yet. Then the shaft position in this case would advantageously be determined as the region from the sixth floor up to and including the seventh floor.

In particular, it is provided that the shaft position is determined as a position interval, wherein the boundaries of the position interval are determined in such a way that the first elevator car is reliably located in the specified position interval. Advantageously, the shaft position is determined as a position interval if the shaft position of the first elevator car cannot be clearly determined by means of the available information. This advantageously ensures that the first elevator car is not outside the determined shaft position.

Advantageously, the quarantine section is determined in such a way that the respective end of the quarantine section is at least one stopping distance from the determined shaft position. If the shaft position is determined as the position interval, the respective end of the quarantine section is advantageously determined in such a way as to be at least one stopping distance from the determined respective boundary of the position interval. The stopping distance is in particular the distance that another elevator car needs to come to a standstill from traveling at maximum speed after the command is issued for an emergency stop. Since the stopping distance is different depending on the direction of travel of an elevator car, in particular, up, down or sideways, in particular it is provided that the distance of the ends of the quarantine section from the respective boundary of the position interval is different.

Advantageously, the other elevator cars in the shaft system will continue to move outside the quarantine section. As a result, the multi-car elevator system advantageously remains ready for use despite the deviation of the multi-car elevator system from the normal operating state. Passengers can still be transported with the other elevator cars of the elevator system.

A further advantageous embodiment of the invention provides that when an elevator car enters the blocked quarantine section, an emergency stop of this elevator car is triggered. This advantageously further increases the safety of the multi-car elevator system. Since the distance of the first elevator car from the respective end of the quarantine section advantageously corresponds at least to the stopping distance of an elevator car, it is advantageously ensured that an elevator car comes to a standstill before the first elevator car and thus a collision is prevented.

According to a further advantageous embodiment of the invention, the elevator cars are operated by means of a linear motor drive in the shaft system, wherein the locked quarantine section is powered off. In that the corresponding linear motor section in the quarantine section is powered off here, advantageously a further elevator car cannot be further moved within the quarantine section. This provides a further measure to effectively prevent a collision between the first elevator car and another elevator car of the multi-car elevator system.

A further particularly advantageous embodiment of the invention provides that for each elevator car of the multi-car elevator system it is calculated at which stopping position the respective elevator car will stop in the event of a shutdown of the respective elevator car with consideration of the current movement parameters of the respective elevator car, wherein at least the respective stopping position is provided as elevator car data. The identification and provision of the respective stopping position is advantageously part of the safety concept of the multi-car elevator system. Such a safety concept is described in the document WO 2016/083115A1. Advantageously, the stopping positions are the “stopping points” described in the document WO 2016/083115 A1. In this respect, full reference is made to the document WO 2016/083115A1. By means of said stopping points, the shaft position of the first elevator car can be advantageously determined with high accuracy. In the absence of the provision of these stopping points, the corresponding elevator car is immediately shut down. Advantageously, the stopping positions are transmitted at time intervals between ten milliseconds and 300 milliseconds. Taking into account the selected transmission interval and the last provided stopping points, the shaft position is advantageously determined. It is also advantageous that the system runtime is also taken into account. This is a maximum of 80 milliseconds in a preferred wireless design.

As a further particularly advantageous embodiment of the invention it is provided that the control system of the multi-car elevator system is a decentralized control system, wherein a cage control unit is assigned to at least each of the elevator cars and the respective cage control unit of an elevator car communicates the data of that elevator car at least to the cage control units of the immediately adjacent elevator cars. Advantageously, in particular elevator cars adjacent to a first elevator car with respect to which the provision of data are not provided are informed immediately. Reaction times of the multi-car elevator system are advantageously shortened as a result. This in turn allows the shaft position to be determined more precisely, whereby the quarantine section can be determined to be smaller, which advantageously leads to a lesser restriction of the conveying capacity.

Advantageously, the determination of the quarantine section also takes into account the positions of elevator cars adjacent to the first elevator car.

Advantageously, defined shaft sections of the shaft system are each assigned to a shaft control unit, wherein the respective cage control unit of an elevator car of the multi-car elevator system communicates the data of at least said elevator car shaft to the control unit of the shaft section in which this elevator car is located when communicating the data. If data of a first elevator car are not communicated to the shaft control unit of the respective shaft section, then a lack of provision of data of this elevator car is detected and this shaft section is advantageously blocked. If the elevator cars are driven by a linear motor drive, this shaft section will be advantageously powered off. If the distance of the elevator car from a next shaft section is less than a predetermined distance, in particular less than the stopping distance of an elevator car, this shaft section is advantageously also blocked as a quarantine section.

According to a further advantageous embodiment of the invention, the lack of the provision of the data of the first elevator car is individually recognized by each control unit to which these data are to be communicated. The detection of the lack of the provision of the data of the first elevator car is advantageously communicated to the other control units. Advantageously, the respective detection times for detecting the lack of the provision of the data are recorded. Finally, the shaft position determination is advantageously further improved taking into account the detected detection times. This can advantageously further improve the determination of the shaft position at which the first elevator car is located in the shaft system, in particular while further taking into account the last transmitted stopping positions.

The multi-car elevator system also proposed for the solution of the above-mentioned problem also includes a shaft system with at least one lift shaft, a plurality of elevator cars that can be individually moved in the shaft system and a control system. The multi-car elevator system is advantageously embodied to perform a method described above, in particular also in any combination of the previously proposed embodiments. The control system is preferably a decentralized control system with a plurality of control units, in particular with the aforementioned cage control units and shaft control units.

Further advantageous details, features and embodiment details of the invention are explained in more detail in connection with the exemplary embodiments shown in the figures. In the figures:

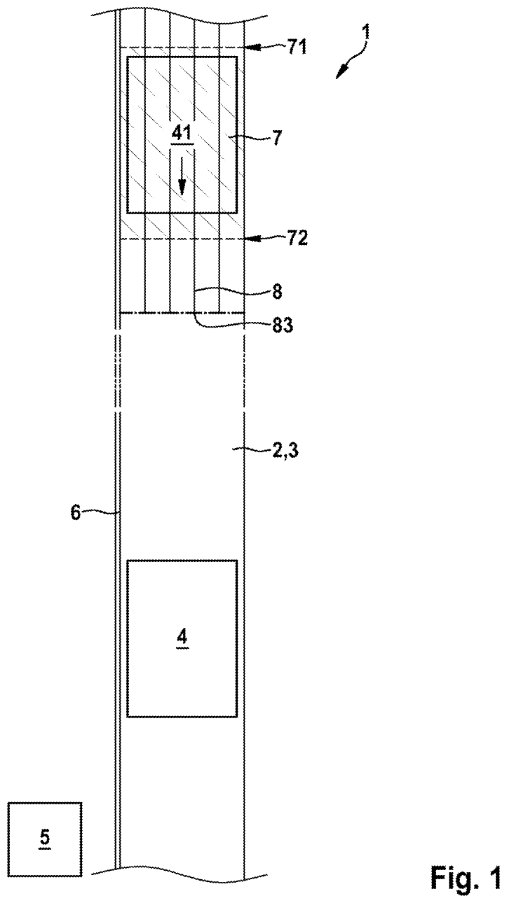

FIG. 1 shows in a simplified schematic representation of an exemplary embodiment of a multi-car elevator system designed according to the invention, which performs an exemplary embodiment of a method designed according to the invention;

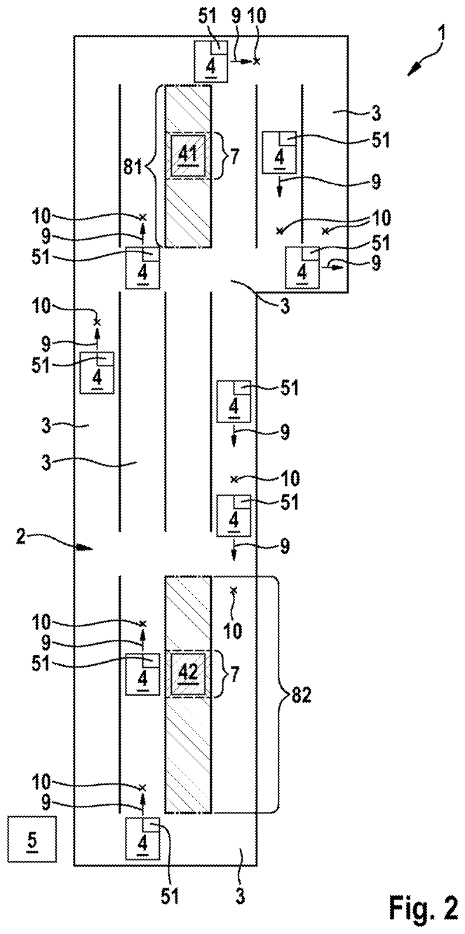

FIG. 2 shows in a simplified schematic representation a further exemplary embodiment of a multi-car elevator system designed according to the invention, which performs a further exemplary embodiment of a method designed according to the invention; and

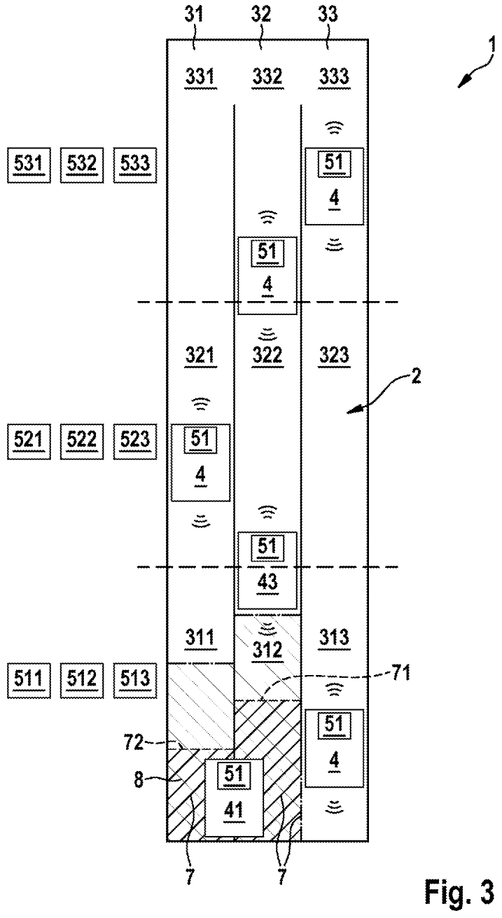

FIG. 3 shows in a simplified schematic representation a further exemplary embodiment of a multi-car elevator system designed according to the invention, which performs a further exemplary embodiment of a method designed according to the invention.

The multi-car elevator system 1 shown in FIG. 1 comprises a shaft system 2 with only one lift shaft 3. In this lift shaft 3, two elevator cars 4, 41 can be moved individually, i.e. largely independently of each other. In particular, it is provided that this is a so-called TWIN® system. The elevator cars 4, 41 are moved in the lift shaft 3 by rope drives. However, other drives can also be provided, such as in particular rack-and-pinion drives, friction wheel drives or linear motor drives.

In addition, the multi-car system 1 comprises a control system 5. In this exemplary embodiment, the control system 5 is designed as a central control system. Moreover, the multi-car elevator system 1 shown in FIG. 1 contains a shaft information system 6, which is in particular embodied to detect each current position of the elevator cars 4, 41 and, moreover, to determine movement parameters of the elevator cars 4,41, in particular the speed, acceleration and/or the jolting of the elevator cars 4,41.

The data of the elevator cars 4, 41 acquired by the shaft information system 6 are provided to the control system 5 at time intervals. The transmission of the data of the elevator cars 4, 41 to the control system 5 takes place in this exemplary embodiment at fixed time intervals, for example at time intervals of ten milliseconds. The specification of the time intervals advantageously depends on the maximum speed of the elevator cars 4, 41 with which the elevator cars 4, 41 are moved in the lift shaft 3 of the multi-car elevator system 1. Advantageously, the higher the maximum speed of the elevator cars 4, 41, the shorter is the time interval to be determined. If the maximum speed of the elevator cars 4, 41 is, for example, twelve m/s (m/s: meters per second), the time interval after which data of the elevator cars 4 41 are provided in each case is preferably not more than 15 milliseconds. If, for example, the maximum speed of the elevator cars 4, 41 is, for example, only 6 m/s, the time interval can be correspondingly longer and, for example, between 15 milliseconds and 25 milliseconds.

The data of the elevator cars 4, 41 provided by the shaft information system 6 of the multi-car elevator system 1 are detected by the control system 5 in this exemplary embodiment. If the shaft information system 6 does not provide data related to one of the elevator cars 4, 41 or related to both elevator cars 4, 41 of the multi-car elevator system 1, so that as a result no data of the elevator cars 4, 41 of the shaft information system 6 are received by the control system 5 after the specified time interval, then the lack of provision of the data is detected by the control system 5.

In particular, it is provided that the communication system or the communication channels for the transmission of the data of the elevator cars 4, 41 from the shaft information system 6 to the control system 5 is embodied redundantly. A lack of the provision of the data of at least one of the elevator cars 4, 41 is advantageously detected in this case only if data of the corresponding elevator car 4, 41 are not provided via any of the redundantly embodied communication channels.

In the exemplary embodiment described with reference to FIG. 1, it is now assumed that in relation to the elevator car 4, as provided in the normal case, data of this elevator car 4 are provided by the shaft information system 6 to the control system 5 at time intervals. With regard to elevator car 41, however, the control system 5 has detected a failure to provide the data of the elevator car 41.

Triggered by the lack of provision of the data of the elevator car 41, the control system 5 determines the shaft position of the elevator car 41. For this purpose, the most recently provided position information provided by the shaft information system 6 is used. Taking into account the movement parameters last known before the provision of the data of the elevator car 41, in particular the direction of travel of that elevator car, the speed of that elevator car 41 and the acceleration of that elevator car 41, the shaft position 7 of the elevator car 41 is determined in such a way that the elevator car 41 is reliably located at the specified shaft position. For this purpose, in this exemplary embodiment, a shaft section is the shaft position 7, so that the shaft position 7 is a position interval with an upper boundary 71 and a lower boundary 72. The position interval, which is defined by the boundaries 71, 72, is larger than the dimensions of the elevator car 41.

Furthermore, the control system 5 of the multi-car elevator system 1 determines a quarantine section 8 of the shaft system 2. The quarantine section 8 is determined in such a way that the determined shaft position 7 and thus, in particular, the elevator car 41 is disposed entirely within the quarantine section 8. The quarantine section 8 is blocked by the control system 5 for the other elevator car 4 of the multi-car elevator system 1, i.e. the elevator car 4 may not enter the quarantine section 8. Floors located below the quarantine section 8, on the other hand, can still be approached and served by the elevator car 4.

On the other hand, the elevator car 41 must not be removed from the quarantine section 8 until the fault is rectified. A further movement of the elevator car 41 in the quarantine section 8 can be provided, in particular a floor stop within the quarantine section 8 in order to allow people in the elevator car 41 to disembark. Such a movement to a next stop is in particular an option if, although data of the elevator car 41 have not been provided via any of the redundantly embodied communication channels after the expiry of one time interval, data of the elevator car 41 are provided after the end of the following time interval, but at least via one of the redundantly embodied communication channels. In particular on the other hand, it is provided as a variant of the method that immediately after a lack of provision of the data of one of the elevator cars 4, 41 an emergency stop of the corresponding elevator car is triggered and that this elevator car may not be moved in the quarantine section 8 until the fault has been rectified.

Due to the fact that the elevator car 4 can continue to be moved outside the quarantine section 8, the operation of the multi-car elevator system 1 can thus be continued at least to a limited extent.

When moving the elevator car 4, it is monitored that this elevator car 4 does not enter the quarantine section 8. If a minimum distance to the quarantine section 8 is undershot by the elevator car 4, an emergency stop of this elevator car 4 is triggered.

The exemplary embodiment represented in FIG. 2 shows a multi-car elevator system 1 that contains a shaft system 2 with a plurality of vertical and horizontal lift shafts 3. The multi-car elevator system 1 also includes a plurality of elevator cars 4 that are individually movable in the shaft system 2. In particular, it is provided that the elevator cars 4 can be moved in the lift shafts 3 by means of a linear motor drive (not explicitly shown in FIG. 2). The multi-car elevator system 1 is also designed in such a way that the elevator cars 4 of the multi-car elevator system 1 can change between the lift shafts 3. For this purpose, in particular, it is provided that the multi-car elevator system 1 includes suitably embodied shaft change units (not explicitly shown in FIG. 2), in particular so-called exchanger units as described in JP 06048672 A, for example.

Furthermore, this exemplary embodiment provides that the multi-car elevator system 1 comprises a control system 5. The control system 5 is a decentralized control system, wherein each of the elevator cars 4 is assigned a cage control unit 51. For each of the elevator cars 4 of the multi-car elevator system 1, the stopping position 10 in which the respective elevator car 4 stops in the event of stopping the respective elevator car 4 is calculated taking into account current movement parameters of the respective elevator car 4, preferably using the respective cage control unit 51. As a driving parameter, in the exemplary embodiment shown in FIG. 2 the direction of travel 9 as well as the current speed and acceleration of the respective elevator car 4 are provided. In particular, it is provided that the stopping positions 10 as described in the document WO 2016/083115 A1 with respect to the “stopping points” will be determined and the stopping positions 10 used as part of the safety concept of the multi-car elevator system 1, as also described in the document WO 2016/083115 A1.

The stopping positions 10 determined with respect to each of the elevator cars 4 of the multi-car elevator system 1 are provided as data of the elevator cars 4. In particular, it is provided that the stopping positions 10 are each sent from the cage control unit 51 of an elevator car 4 to the cage control units 51 of the immediately adjacent elevator cars 4 and are thus provided. Immediately adjacent elevator cars 4 are the subsequent and preceding elevator cars, between which no other elevator cars are moving. In other words, in this exemplary embodiment a cage control unit 51 always transmits the stopping positions 10 to at least two additional cage control units 51. If an elevator car 4 of the multi-car elevator system 1 is located in an area near the shaft change units, it is in particular provided that the cage unit 51 transmits the respective stopping position 10 to more than two other cage control units 51, since in this case in particular there are not absolutely necessarily just a single subsequent elevator car or a single preceding elevator car.

If the provision of the stopping position 10 is not available as data of an elevator car 4 of the multi-car elevator system 1, then the stopping position 10 of the elevator car 4 of the multi-car elevator system 1 will not be received by at least one cage control unit 51, so the affected elevator car 4 will be stopped and the shaft position 7 thereof in the shaft system 2 will be determined. The determination of the shaft position 7 of the elevator car 4 is carried out using the last recorded stopping position 10 with respect to this elevator car 4, taking into account the predetermined time interval for the provision of the stopping position 10 as well as more advantageously taking into account system running times, in particular taking into account the durations for the transmission of the stopping position 10 from one cage control unit 51 to another cage control unit 51. In particular, it is provided that the stopping positions 10 of the elevator cars 4 are transmitted wirelessly, in particular via WLAN (WLAN: Wireless Local Area Network), wherein the maximum duration for the data transfer is set to 80 milliseconds. As a result of the fact that the stopping position 10 of the elevator cars can be determined in the specified time intervals and thus virtually continuously, the shaft position 7 can advantageously be determined very precisely. The position interval describing the shaft position 7 is in this respect advantageously not or only slightly greater than the dimensions of an elevator car 4 of the multi-car elevator system 1.

In the exemplary embodiment shown in FIG. 2, it is now assumed that the provision of the stopping position 10 of a first elevator car 41 as well as the provision of the stopping position 10 of a further first elevator car 42 is lacking after the predetermined time interval. The elevator cars 41, 42 are then stopped, in particular by triggering an emergency stop of the elevator cars 41, 42. The shaft positions 7 of the elevator cars 41, 42 are identified and in each case a quarantine section 81, 82 of the shaft system 2 is determined, in which the respective elevator car 41, 42 is reliably located. In particular, the quarantine sections 81, 82 are also determined in such a way that the respective end of the respective quarantine section 81, 82 is at a greater distance from the determined shaft position 7 than a stopping distance of a further elevator car 4 of the multi-car elevator system 1.

The quarantine sections 81, 82 will be blocked for the other elevator cars 4 of the multi-car elevator system 1, i.e. the other elevator cars 4 of the multi-car elevator system 1 may not enter the specified quarantine sections 81, 82. This is achieved in this exemplary embodiment by the fact that the part of the linear motor drive of the multi-car elevator system 1 that is responsible for the quarantine sections 81, 82 is powered off.

FIG. 3 shows another exemplary embodiment of a multi-car elevator system 1. The multi-car elevator system 1 contains a shaft system 2 with three lift shafts 31, 32, 33. The multi-car elevator system 1 also contains a plurality of individually movable elevator cars 4. In particular, it is provided that the elevator cars 4 of the multi-car elevator system 1 are moved within the shaft system 2 by means of a linear motor drive. Furthermore, the multi-car lift system 1 contains a decentralized control system, wherein the elevator cars 4 each comprise a cage control unit 51. In addition, defined shaft sections 311 to 333 are each assigned a shaft control unit 511 through 533, namely the shaft control unit 511 to the shaft section 311, the shaft control unit 512 to the shaft section 312, etc.

Data of the elevator cars 4 are provided at predetermined time intervals. In this case, data of an elevator car 4 of the multi-car elevator system 1 are in particular movement parameters of the respective elevator car 4, such as speed and acceleration as well as position data of the respective elevator car 4. Said movement parameters and position data of an elevator car 4 are detected as data by the respective cage control unit 51 and are sent to other control units of the decentralized control system. The transmission of the data from the respective cage control units 51 is carried out wirelessly in this exemplary embodiment, in particular by means of a radio connection, which is represented in FIG. 3 by symbolized radio waves.

In this exemplary embodiment, the data of a cage control unit 51 are sent to the cage control units 51 of adjacent elevator cars, in particular to cage control units 51 of the elevator car immediately following the respective elevator car 4 as well as of the elevator car immediately preceding the respective elevator car 4.

In addition, the data of a cage control unit 51 are also transmitted to the respective shaft control unit of the shaft section in which the respective elevator car 4 is located at the time of the communication of the data of the elevator car 4. For example, the elevator car 43 transmits the data to the immediately preceding and immediately following elevator cars 4, 41 and to the shaft control unit 522 of the shaft section 322 and to the shaft control unit 512 of the shaft section 312.

The movement of the elevator cars 4 of the multi-car elevator system 1 in the shaft system 2 is controlled using said data. In particular, the assignment of elevator cars 4 to calls submitted by users is made taking into account said data, in particular the assignment of elevator cars to destination calls submitted by users. In addition, said data are advantageously used to ensure safe movement of the elevator cars 4 within the shaft system 2. In particular, the data are used to maintain safety distances between elevator cars 4 of the elevator system.

In particular, it is provided that in this exemplary embodiment a confirmation signal is sent as further data from the cage control units 51, 511 through 533, if said data have been received from the other control units 51, 511 through 533. In this way, it is advantageously ensured that data sent from a control unit 51 are actually received by at least one of the neighboring control units 51, 511 through 533. A lack of the provision of data from the elevator cars 4, i.e. in the present case a lack of transmission of the aforementioned movement parameters and position data as well as the lack of a confirmation signal are detected by the control system in this case.

With regard to the exemplary embodiment shown in FIG. 3, it is assumed that the elevator car 41 is intended to change from the shaft section 312 to the shaft section 311. In the shaft section 312, the provision of data of the elevator car 41 is lacking in this case, i.e. in particular the control unit 512 and the shaft control unit 511 as well as the cage control units 51 of the elevator cars 4, 43 have not received any data from the cage control unit 51 of the elevator car 41.

Due to this lack of provision of the data of the first elevator car 41, the elevator car 41 is stopped and a probable shaft position 7 of this stopped elevator car 41 is determined. The probable shaft position 7 of the elevator car 41 is determined by the control system as a position interval, wherein the boundaries 71, 72 of the position interval are determined in such a way that the stopped elevator car 41 is reliably located within the specified shaft position 7. Since the elevator car 41 was on the downward journey from the shaft section 312 and the shaft change from the shaft section 312 to the shaft section 311 was comparatively slow in this case, the upper boundary 71 of the position interval is further away from the elevator car 41 than the lower boundary 72 of the position interval.

In particular, it is provided that the lack of provision of the data of the first elevator car 41 is individually recognized by each control unit 51, 511 through 533, to which said data should be communicated. Thereupon, the recognition of the lack of provision of the data of the first elevator car 41 is communicated by the cage control unit 51 thereof to the other control units 51, 511 through 533, in particular to the other cage control units 51 of adjacent elevator cars 4, 43 and the shaft control units 511, 512. The resulting respective detection time of the control units 51, 511 through 533 for detecting the lack of the provision of the data is recorded and the probable shaft position 7 is determined while further taking into account the detected detection times.

Instead of determining detection times, a maximum detection time that can occur under the most unfavorable conditions can be specified, in particular a detection time of 80 milliseconds.

After determining the shaft positions 7, a quarantine section 8 of the shaft system 2 in which the first elevator car 41 is located is determined by the control system. The quarantine section 8 extends beyond the boundaries 71, 72 of the position interval in this case. The quarantine section 8 of the shaft system 2 is blocked for the other elevator cars 4, 43 of the multi-car elevator system 1. The further elevator cars 4, 42 of the multi-car elevator system 1 will continue to move in the shaft system 2 outside the quarantine section 8. If an elevator car 43 of the multi-car elevator system 1 is moved in such a way that said elevator car 43 falls below a safety distance from the quarantine section 8 specified by the control system or even enters the quarantine section 8, the control system immediately triggers an emergency stop of said elevator car 43.

The exemplary embodiments shown in the figures and described in connection with the figures are used to explain the invention and do not restrict the invention. In particular, the components shown in the figures are not shown to scale.

### REFERENCE LIST

1 Multi-car elevator system
2 Shaft system
3 Lift shaft
31 Lift shaft
32 Lift shaft
33 Lift shaft
311 Shaft section
312 Shaft section
313 Shaft section
321 Shaft section
322 Shaft section
323 Shaft section
331 Shaft section
332 Shaft section
333 Shaft section
4 Elevator car
41 First elevator car
43 Elevator car
5 Control system
51 Cabin control unit
511 Shaft control unit
512 Shaft control unit
513 Shaft control unit
521 Shaft control unit
522 Shaft control unit
523 Shaft control unit
531 Shaft control unit
532 Shaft control unit
533 Shaft control unit
6 Shaft information system
7 Shaft position
71 Upper boundary of the probable shaft position 7
72 Lower boundary of the probable shaft position 7
8 Quarantine section
9 Direction of travel
10 Stopping position

1.-15. (canceled)

16. A method of operating a multi-car elevator system that comprises a shaft system with at least one lift shaft, a plurality of elevator cars individually movable in the shaft system, and a control system, the method comprising:
providing data of the elevator cars at time intervals,
determining, in the absence of the provision of the data of a first elevator car of the multi-car elevator system, a shaft position of said first elevator car,
determining a quarantine section of the shaft system in which the first elevator car is located using the determined shaft position, and
blocking access to the determined quarantine section for the other elevator cars of the multi-car elevator system.

17. The method of claim 16, including:
collecting, by the control system, the provided data, and
detecting, by the control system, the lack of provision of the data of the first elevator car.

18. The method as claimed in claim 16, including:
providing position data of the elevator cars with respect to the position of the respective elevator car of the multi-car elevator system in the shaft system as said data at time intervals.

19. The method of claim 16, wherein the control system determines the probable shaft position of the first elevator car by taking into account at least one of the following criteria: the last detected position data of the first elevator car; the last detected movement parameters of the first elevator car; the last detected destination floors of the first elevator car; signal durations for providing the data of the elevator cars; or the last detected error messages.

20. The method of claim 16, wherein the probable shaft position is determined as a position interval, wherein boundaries of the position interval are determined such that the first elevator car is reliably located in the specified position interval.

21. The method of claim 16, wherein the quarantine section is determined such that the respective end of the quarantine section is at least one stopping distance from the determined shaft position.

22. The method of claim 16, wherein in the event of a lack of provision of the data of the first elevator car the first elevator car is stopped.

23. The method of claim 16, wherein the other elevator cars in the shaft system continue to operate outside the quarantine section.

24. The method of claim 16, wherein when one of the plurality of elevator cars enters the blocked quarantine section an emergency stop of said elevator car is triggered.

25. The method of claim 16, wherein the elevator cars are moved in the shaft system by means of a linear motor drive, wherein the blocked quarantine section is powered off.

26. The method of claim 16, wherein for each elevator car of the multi-car elevator system, the stopping position at which the respective elevator car stops in the event of stopping the respective elevator car is calculated taking into account current movement parameters of the respective elevator car, wherein at least the respective stopping position is provided as said data of the elevator cars.

27. The method of claim 16, wherein the control system is a decentralized control system, wherein at least each of the elevator cars is assigned a cage control unit and the respective cage control unit of an elevator car communicates the data of said elevator car at least to the cage control units of the immediately adjacent elevator cars.

28. The method of claim 27, wherein defined shaft sections of the shaft system are each assigned a shaft control unit wherein the respective cage control unit of an elevator car of the multi-car elevator system communicates the data of that elevator car at least to the shaft control unit of that shaft section in which the elevator car is located when communicating the data.

29. The method of claim 27, wherein the lack of provision of the data of the first elevator car is individually recognized by each control unit to which said data are to be communicated, the recognition of the lack of provision of the data of the first elevator car is communicated to the other control units, the respective detection time of the recognition of the lack of provision of the data is detected and the shaft position is determined while taking into account the detected detection times.

30. A multi-car elevator system containing a shaft system with at least one lift shaft, a plurality of elevator cars individually movable in the shaft system and a control system, wherein the multi-car elevator system is configured to provide data of the elevator cars at time intervals, determine, in the absence of the provision of the data of a first elevator car of the multi-car elevator system, a shaft position of said first elevator car, determine a quarantine section of the shaft system in which the first elevator car is located using the determined shaft position, and block access to the determined quarantine section for the other elevator cars of the multi-car elevator system.
